(19) United States
(12) Patent Application Publication
(10) Pub. No.: US 2025/0360917 A1
(43) Pub. Date: Nov. 27, 2025

(54) METHOD FOR OPERATING A VEHICLE, AND VEHICLE

(71) Applicant: Ford Global Technologies, LLC, Dearborn, MI (US)

(72) Inventors: Markus Krekel, Wermelskirchen (DE); Tobias Kran, Erftstadt (DE)

(73) Assignee: Ford Global Technologies, LLC, Dearborn, MI (US)

(21) Appl. No.: 19/210,662

(22) Filed: May 16, 2025

(30) Foreign Application Priority Data
May 23, 2024 (DE) 102024114487.4

(51) Int. Cl. B60W 30/06; B60W 30/182; B60W 50/08; B60W 50/10; B60W 50/14; G05D 1/223; G05D 109/10

(52) U.S. Cl. CPC B60W 30/06; B60W 30/182; B60W 50/082; B60W 50/10; B60W 50/14; G05D 1/223; B60W 2540/215; G05D 2109/10

(57) ABSTRACT

The disclosure relates generally to a vehicle and a method for operating a vehicle. The vehicle comprises at least one sensor device and a control device coupled with the sensor device. At least environmental data of the vehicle are acquired by the sensor device. An automated parking maneuver is triggered by a remote-control command of a user of the vehicle. The control device is configured to determine, at least on the basis of the acquired environmental data, whether the automated parking maneuver is a park-out maneuver or a park-in maneuver. A start command is triggered by the control device if the automated parking maneuver is a park-out maneuver. The vehicle is not switched off in consequence of the start command. Alternatively, a switch-off command is triggered by the control device if the automated parking maneuver is a park-in maneuver. The vehicle is switched off in consequence of the switch-off command.

### CROSS-REFERENCE TO RELATED APPLICATIONS

The present application claims priority to and the benefit of German Application No. 102024114487.4, filed May 23, 2024, which is hereby incorporated by reference herein in its entirety.

### FIELD

The invention relates generally to a method for operating a vehicle, and to a vehicle.

### BACKGROUND

Automated parking maneuvers are common comfort functions in modern vehicles. In the meantime, it has likewise become possible to trigger such maneuvers by remote control. In the case of previous approaches, the vehicle is switched off at the end of every automated, remotely triggered parking maneuver. This is sensible when parking in, but it can be annoying when parking out, since the user then has to start the vehicle again if he wants to drive off. For reasons of functional reliability and from the point of view of environmental protection and the possible generation of a local exhaust gas atmosphere, for example in enclosed spaces, it is not possible simply to leave the vehicle switched on after such automated, remotely triggered parking maneuvers. Moreover, it is also not sensible if the automated, remotely triggered parking maneuver is a park-in maneuver.

Although previous approaches, as known, for example, from US20200086851A1, US20170329346A1, JP2021525675A, take account of specific decisions regarding the switching off of the vehicle in individual situations, see for example U.S. Pat. No. 9,739,226B2, previous decision behavior has been limited to special cases. Comfort for the vehicle user is therefore low.

There is therefore a need to eliminate or at least reduce the disadvantages of known methods for operating a vehicle and vehicles. In particular, there is a need to configure a method for operating a vehicle and a vehicle such that comfortable operability is ensured for the vehicle user in respect of the switching off or starting of a vehicle following a parking maneuver.

### SUMMARY

The object is achieved by the subject matter of the independent patent claims. Advantageous embodiments are indicated in the dependent patent claims and the following description, each of which can illustrate aspects of the disclosure on its own or in (sub) combination. Some features are explained in relation to methods, others in relation to devices. The corresponding aspects are, however, mutually applicable in a corresponding manner.

According to one aspect, some embodiments of the disclosure relate to a method for operating a vehicle. The vehicle comprises at least one sensor device and a control device coupled with the sensor device. The method comprises at least the following steps:

At least environmental data of the vehicle are acquired by the sensor device.

An automated parking maneuver is triggered by a remote-control command of a user of the vehicle.

It is determined by the control device, at least on the basis of the acquired environmental data, whether the automated parking maneuver is a park-out maneuver or a park-in maneuver.

A start command is triggered by the control device if the automated parking maneuver is a park-out maneuver determined by the control device. The vehicle is not switched off in consequence of the start command.

Alternatively, a switch-off command is triggered by the control device if the automated parking maneuver is a park-in maneuver determined by the control device. The vehicle is switched off in consequence of the switch-off command.

The present method is based on the finding that a decision logic, which is stored in the control device, can be used to distinguish between different parking maneuvers. On the basis of the determination of whether the remotely triggered automated parking maneuver is a park-in maneuver or a park-out maneuver, a corresponding command is triggered in order to initiate or to prevent a switching off of the vehicle. Consequently, it can advantageously be prevented that the vehicle is unnecessarily switched off in the case of park-out maneuvers and subsequently has to be started again by the user in order to be operated further. On the other hand, it can be ensured that the vehicle is switched off if the parking maneuver is a park-in maneuver. Since the decision logic of the control device is adapted to differentiate between different situations, comfort for the user is increased since he no longer has to concern himself with the activity state of the vehicle. Since the decision processes result in the immediate issue of commands, the environmental impact can also be lowered and the fuel or energy expenditure of the vehicle can be reduced.

According to a further aspect, some embodiments of the disclosure relate also to a vehicle having at least one sensor device and a control device coupled with the sensor device. The sensor device is at least adapted to acquire at least environmental data of the vehicle. The control device is at least adapted:
to trigger an automated parking maneuver of the vehicle in consequence of a remote-control command received from a user,
to determine, at least on the basis of the acquired environmental data, whether the automated parking maneuver is a park-out maneuver or a park-in maneuver, and
to trigger a start command if the automated parking maneuver is a park-out maneuver determined by the control device, wherein the vehicle is not switched off in consequence of the start command, and
to trigger a switch-off command if the automated parking maneuver is a park-in maneuver determined by the control device, wherein the vehicle is switched off in consequence of the switch-off command.

The advantages which are ensured by the method explained herein are also achieved in a corresponding manner by the described vehicle.

The environmental data are here understood as being measured values which are acquired in respect of a vehicle environment. The environmental data are in particular such that objects, such as, for example, obstacles, vehicles or people, can be recognized on the basis of the environmental data. The sensor device transmits the environmental data to the control device. The control device is adapted in particular to recognize objects, such as walls, bollards, curbs, vehicles and/or people, in the environment of the vehicle on the basis of the environmental data. The relative position or absolute position of the objects, vehicles or people in question relative to the vehicle can of course also be determined by the control device.

Optionally, the sensor device comprises at least one of a camera-based sensor, a lidar and a radar.

Preferably, the vehicle can also comprise a plurality of separate sensor devices, which together acquire the environmental data. The environmental data are then based on partial acquisitions carried out by the individual sensor devices.

In some embodiments, the remote-control command is transmitted wirelessly to the vehicle, in particular to the control device thereof. To this end, the control device comprises or is coupled with a communication device. For example, the remote-control command can be triggered and transmitted by an application (app) of a smartphone or tablet, or alternatively by a remote-control device, such as a radio key fob.

In consequence of the remote-control command, the automated parking maneuver is also triggered. This can optionally be effected by the control device. Alternatively, this can also be effected by another control device of the vehicle, such as a higher-level vehicle control device.

In some embodiments, the decision whether the automated parking maneuver is a park-in maneuver or a park-out maneuver is made by the control device at least also on the basis of recognized or unrecognized objects, vehicles and/or people, which are recognized by the control device on the basis of the received environmental data. This means that the control device is adapted to recognize environment configurations of the vehicle before, during and after the automated park-in maneuver, for example whether the vehicle is or is not arranged between obstacles.

Preferably, the starting (not switching off) or switching off of the vehicle is also actually triggered, in particular also performed, by the control device. Alternatively, the control device can, however, also transmit the corresponding start commands and switch-off commands to another control device of the vehicle, for example a higher-level vehicle control device, which controls the actual switching off or not switching off of the vehicle. For example, the higher-level vehicle control device can exercise control over an ignition and/or an engine operating state of the vehicle.

Optionally, the automated parking maneuver is determined by the control device as being a park-out maneuver at least when the control device determines, on the basis of the acquired environmental data, that the vehicle was arranged in a dedicated parking position before the automated parking maneuver. This means that the control device determines whether the vehicle, before the automated parking maneuver, was arranged such that the parking maneuver can only be a park-out maneuver because, on account of the parking position, the vehicle was undoubtedly parked before the parking maneuver. This is used by the decision logic of the control device as the decision criterion for recognizing that the vehicle will continue to be used by the user after the automated parking maneuver.

A dedicated parking position is to be understood as being a parking position that undoubtedly indicates a parked situation of the vehicle.

Optionally, a dedicated parking position can be understood, for example, as being a position of the vehicle in which the vehicle is arranged in a garage or a carport. A dedicated parking position can also be recognized by the fact that the vehicle is arranged between adjacent boundaries, such as walls, bollards or vehicles. The control device can take account of the respective distances between the vehicle and the objects, said distances being determinable by the control device from the acquired environmental data. For example, the vehicle can also be arranged between vehicles in normal road situations, so that a triggering of an automated parking maneuver can then also correspond to a park-in maneuver. However, for conventional road situations, the side, front or rear distances are typically greater compared to actual parked arrangements (parked situations) of the vehicle.

In some embodiments, the automated parking maneuver is determined by the control device as being a park-in maneuver at least when the control device determines, on the basis of the acquired environmental data, that the vehicle is arranged in a dedicated parking position after the automated parking maneuver. This means that the acquisition of the environmental data is also continued during the automated parking maneuver. This allows the control device to recognize whether the vehicle assumes a dedicated parking position after the automated parking maneuver. This is then used by the decision logic to establish that the automated parking maneuver is a park-in maneuver. Consequently, it is to be assumed that the vehicle is to be switched off because the vehicle user will not use the vehicle further. Triggering of the switch-off command is therefore initiated. It can thus be ensured that the vehicle does not have to be switched off manually by the user and, in addition, also that the vehicle does not continue to be activated for an unnecessary period of time after the automated parking maneuver. The fuel or energy expenditure of the vehicle can thus be reduced.

Optionally, the vehicle is switched off immediately in consequence of the triggered switch-off command. This is particularly efficient as regards fuel or energy expenditure.

Preferably, the vehicle is not switched off in consequence of a start command at least for a first time interval. The start command is triggered by the control device when it is to be assumed that the vehicle user wishes subsequently to continue to operate the vehicle, for example in order to make a journey. It is therefore advantageous for the vehicle not to be switched off for the first time interval despite the automated parking maneuver. This allows the user to perform actions in preparation for a journey, for example. For example, the first time interval can be sufficient for the user to be able to seat himself in the vehicle, store luggage, select a route or the like. Despite these actions, which require a certain period of time, the vehicle remains switched on so that the vehicle user does not have to manually switch the vehicle on again. Thus, he can subsequently begin the journey immediately. Comfort for the user is increased as a result.

In some embodiments, vehicle functionalities are also detected by the at least one sensor device. The vehicle is not switched off in consequence of a start command at least for a second time interval if, on the basis of the detected vehicle functionalities, it is determined by the control device that a driver's door has been opened within the first time interval. The second time interval is longer than the first time interval. The first time interval allows the driver to perform actions in preparation for a journey. These also include taking a seat within the vehicle interior. To this end, the driver will open the driver's door. This can be detected by the sensor device. In consequence of the driver's door being opened, the period of time corresponding to the second time interval within which the vehicle is not switched off can be lengthened. If the driver's door is not opened within the first time interval, then this is used by the decision logic of the control device to recognize that the driver apparently (at least not immediately) wishes to continue to use the vehicle. Therefore, the vehicle can be switched off at the end of the first period of time and in the case where an operation of opening the driver's door is not detected. A possibly incorrect decision behavior of the control device can thus be corrected automatically. Consequently, the fuel or energy expenditure of the vehicle can be reduced compared to the situation in which the vehicle remains permanently switched on where a park-out maneuver is determined. Moreover, the vehicle user is advantageously given additional time, in dependence on an operation of opening the driver's door, to actually begin the journey without the vehicle being switched off.

Optionally, the automated parking maneuver is determined as being a park-out maneuver if the driver's door has not been opened within a third period of time before the automated parking maneuver. The fact that the driver's door is not opened suggests that the vehicle was arranged in a parked configuration before the automated parking maneuver.

The vehicle functionalities can be understood as being usage functions of the vehicle that are detectable by sensor devices. For example, the detected vehicle functionalities can also include the operation of navigation devices, multimedia devices, ventilation devices, operations of opening a boot or the like. On the basis of whether a corresponding vehicle functionality has been detected within the third period of time before the automated parking maneuver, it can be determined that the vehicle was in use or was not in use before the automated parking maneuver. If it is determined that the vehicle was not in use, it can be assumed that the vehicle was previously in a parked configuration, and the automated parking maneuver is therefore determined as being a park-out maneuver. If vehicle functionalities have been determined such that the vehicle was in use before the automated parking maneuver, the control device determines that the automated parking maneuver is a park-in maneuver. For example, it is also possible to detect, in respect of the vehicle functionalities, whether a door is opened from the outside or from the inside. This makes it possible to determine whether a user is leaving or entering the vehicle, for example after the automated parking maneuver, which can likewise be used for determining a park-in maneuver or a park-out maneuver.

In some embodiments, at least the first time interval is adjustable within a predefined time interval by a user input. The predefined time interval avoids the first time interval being lengthened to an inadmissibly long period of time. It can thus be ensured that, for example, exhaust gas atmospheres cannot be generated. Nevertheless, the variability of the method is increased by the adjustability.

Preferably, the method additionally comprises the following step:
an environment situation in which the vehicle is arranged is determined by the control device at least on the basis of the acquired environmental data. The control device determines that the automated parking maneuver is a park-out maneuver at least when the determined environment situation corresponds to a public area environment.

The public area environment, for example a public car park, is used as the decision criterion for determining that the automated parking maneuver is a park-out maneuver. This is because a park-in maneuver is typically carried out manually by the driver in the case of public car parks. By contrast, the environment situation can also indicate that the area is a private area. In this case, it may sometimes not be possible for the decision to be determined directly. The decision whether the environment is a public area environment or a private area can be made, for example, on the basis of whether the environmental data indicate that there is traffic behavior in the environment of the vehicle.

Optionally, the method additionally comprises the following:
a message is outputted to a vehicle user by the control device via an output device of the vehicle. The message includes information about the triggered start command or switch-off command. The message includes a request for a user input, by means of which the triggered start command or switch-off command can be overridden. If a user input is not made in response to the request, the triggered start-up command or switch-off command is not overridden.

The vehicle user is thus notified of the decision behavior of the control logic of the control device and given the opportunity to manually correct the effects of the respective command, if desired.

The output device can preferably comprise a display and/or a loudspeaker. The output device can also be part of a multimedia device of the vehicle.

In some embodiments, the method additionally comprises the following:
a user input is received via an input device of the vehicle. The start command or switch-off command triggered by the control device is overridden by the user input.

Consequently, the start or switch-off function, triggered by the control device, of the vehicle is corrected in accordance with the user's wishes. The user is thus able to influence the method according to his wishes if the decision of the control device was not appropriate for the situation in question.

The input device can comprise, for example, a switch or an operating element. The input device can additionally likewise be part of a multifunctional device (multimedia device).

Preferably, the vehicle comprises a memory device coupled with the control device. The method then additionally comprises the following:
a dataset is stored in the memory device by the control device in consequence of a triggered automated parking maneuver. The dataset comprises at least activity information, a time value and/or a location value. The activity information indicates whether a start command or a switch-off command has been triggered in consequence of the triggered automated parking maneuver and/or whether a respective start command or a switch-off command has been corrected by a user input. The time value indicates a time of day and/or day of the week at or on which the automated parking maneuver was triggered. The location value indicates a position at which the automated parking maneuver was triggered.

The time value and/or location value are associated with the respective activity information relating to a specific automated parking maneuver.

A database is thus created in respect of the determined decision behavior of the decision logic of the control device. In addition, corresponding user corrections in respect of the automated decision behavior are stored. On the basis of the stored datasets, the decision behavior of the control device can be adapted and configured to be more appropriate, so that it corresponds more accurately to the user's wishes. Advantageously, the database can be evaluated in respect of past decisions and user corrections, since corresponding location values and/or time values, for example, give an indication of repeated behaviors of the vehicle user. This permits learning processes, in order to configure the decision behavior of the control logic to be more in line with requirements, so that, for example, any user corrections that are initially required are preventable after a certain learning phase. Comfort for the user is increased further as a result.

Optionally, the vehicle user can automatically be given the option, in a user dialog, of controlling the vehicle on the basis of a start command or a switch-off command even during a learning phase. After the learning phase, the vehicle user can be offered the option of allowing the decision behavior to be performed automatically by the control logic of the control device, for example once a sufficient wealth of experience has been built up.

In some embodiments, the method additionally comprises the following:
a dataset is retrieved from the memory device by the control device, in consequence of a triggered parking maneuver, on the basis of the time value and/or the location value for the triggered parking maneuver, and
a start command or a switch-off command is triggered in dependence on the activity information of the retrieved dataset.

Since the time value and/or the location value give(s) an indication of repeated behaviors of the vehicle user, they can be used to identify a dataset in accordance with which an automated parking maneuver has previously been carried out in a corresponding manner. The control device then determines the activity information of the corresponding dataset and triggers the start command or switch-off command specified by the activity information. Thus, if the activity information of the dataset indicates that an automated parking maneuver was previously triggered at a similar time of day and/or at a similar position and the command at that time was not corrected by a user input, the corresponding command is triggered by the control device also in relation to the current automated parking maneuver. If the command at that time was corrected by a user input, this is correspondingly taken into account by the control device and the triggered command is changed.

Optionally, at least interior data of a vehicle interior of the vehicle are also acquired by the sensor device. The method then additionally comprises the following:
a position profile of a vehicle user is determined by the control device on the basis of the acquired environmental data and/or interior data, and
it is determined by the control device, at least on the basis of the determined position profile of the vehicle user, whether the automated parking maneuver is a park-out maneuver or a park-in maneuver.

The position profile of a vehicle user can be used as an indication for determining whether the user is about to continue to operate the vehicle or to switch it off after the automated parking maneuver. For example, a position profile of the vehicle user such that he is in the region of a boot of the vehicle but his movement there is of only short duration indicates that the vehicle user was unable to open the boot before the maneuver, for example for lack of space. It is then to be assumed that he wishes to switch off the vehicle and does not wish to operate it further. Accordingly, the parking maneuver is a park-in maneuver and a switch-off command is triggered. The position profile can of course also be examined in respect of other typical position profiles in order to recognize park-in maneuvers or park-out maneuvers on the basis of the user behavior.

In some embodiments, the method additionally comprises the following:
at least also usage periods of the vehicle are acquired by the sensor device, and/or
usage data of the vehicle are received by the control device. The usage periods of the vehicle are established by the usage data, and
it is determined by the control device, at least on the basis of the usage periods of the vehicle, whether the automated parking maneuver is a park-out maneuver or a park-in maneuver.

The control device can receive the usage data, for example, from a higher-level vehicle control device, which monitors vehicle parameters such as speed, climate parameters, multimedia usage, navigation functionalities. Consequently, it is established by means of the usage data and/or usage periods whether the vehicle was used, in particular in accordance with a driving functionality, within a certain period of time before the remotely triggered automated parking maneuver was triggered. If that is the case, it can be assumed that the automated parking maneuver is a park-in maneuver. If no such driving functionalities were used, it can be assumed that the automated parking maneuver is a park-out maneuver. Additional information is thus used within the decision behavior of the control device, so that the likelihood of a correct assessment by the control device is increased.

Optionally, the method is configured as a computer-implemented method. This means that the method steps can be performed with the assistance of one or more data processing devices. In particular, a data processing device can trigger or perform the corresponding steps.

According to a further aspect, the disclosure relates also to a computer program product comprising commands which, when the program is executed by a computer, cause the computer to perform the method as described herein. The advantages achieved by the method described herein are also achieved in a corresponding manner by the computer program product.

According to an additional aspect, the disclosure relates also to a computer-readable storage medium comprising commands which, when the program is executed by a computer, cause the computer to perform the method as described herein. The advantages achieved by the method described herein are also achieved in a corresponding manner by the computer-readable storage medium.

Within the context of the disclosure, vehicles can include in particular land vehicles, namely, inter alia, off-road and road vehicles such as passenger cars, buses, trucks and other commercial vehicles. Vehicles can be manned or unmanned. Vehicles can be at least partially electrically driven, comprise a combustion engine and/or an electric motor serving to drive them.

All the features explained in relation to the various aspects can be combined individually or in (sub-) combination with other aspects.

### BRIEF DESCRIPTION OF THE DRAWINGS

The disclosure as well as further advantageous embodiments and developments thereof will be described and explained in greater detail hereinbelow with reference to the examples shown in the drawings, in which:

FIG. 1 shows a simplified schematic representation of a vehicle according to one embodiment,

FIG. 2 shows a simplified schematic representation of a method for operating a vehicle according to one embodiment, and

FIGS. 3 to 5 show simplified schematic representations of exemplary environment situations within the context of the method.

### DETAILED DESCRIPTION

The following detailed description in conjunction with the accompanying drawings, in which identical numerals relate to identical elements, is intended as a description of different embodiments of the disclosed subject matter and is not to represent the individual embodiments. Each embodiment described in this disclosure serves merely as an example or illustration and is not to be interpreted as being preferred or advantageous over other embodiments. The illustrative examples contained herein do not claim to be complete and do not limit the claimed subject matter to the precise disclosed forms. Various modifications of the described embodiments are readily identifiable to a person skilled in the art, and the general principles defined herein can be applied to other embodiments and applications without departing from the spirit and scope of the described embodiments. Therefore, the described embodiments are not limited to the embodiments shown but have the greatest possible scope of application that is compatible with the principles and features disclosed herein.

All the features disclosed hereinbelow in relation to the exemplary embodiments and/or the accompanying figures can be combined on their own or in any desired sub-combination with features of the aspects of the disclosure, including features of preferred embodiments, provided that the resulting feature combination is meaningful to a person skilled in the technical field.

For the purposes of the disclosure, the wording “at least one of A, B and C” means, for example, (A), (B), (C), (A and B), (A and C), (B and C) or (A, B and C), including all further possible combinations if more than three elements are listed. In other words, the expression “at least one of A and B” generally means “A and/or B”, namely “A” on its own, “B” on its own or “A and B”.

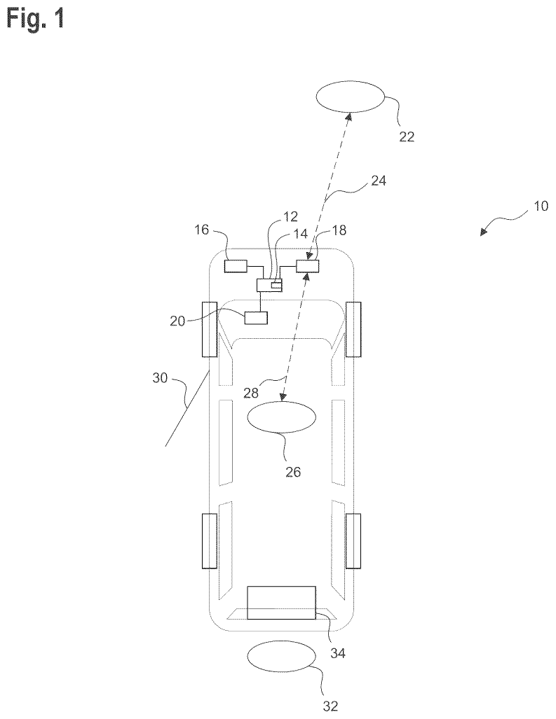

FIG. 1 shows a simplified schematic representation of a vehicle 10 having a control device 12 according to one embodiment. The control device 12 comprises at least one data processing device 14.

The vehicle 10 additionally comprises at least one memory device 16, which is coupled with the control device 12. Datasets can be stored in the memory device 16 by the control device 12 and thus a database, to which the control device 12 has access, can be built.

In addition, the vehicle 10 comprises at least one sensor device 18, which is likewise coupled with the control device 12. The sensor device 18 can comprise different types of sensor, such as, for example, a camera-based sensor, radar or lidar. Other types of sensor are generally also possible, such as, for example, infrared. The sensor device 18 is adapted to transmit acquired sensor data to the control device 12.

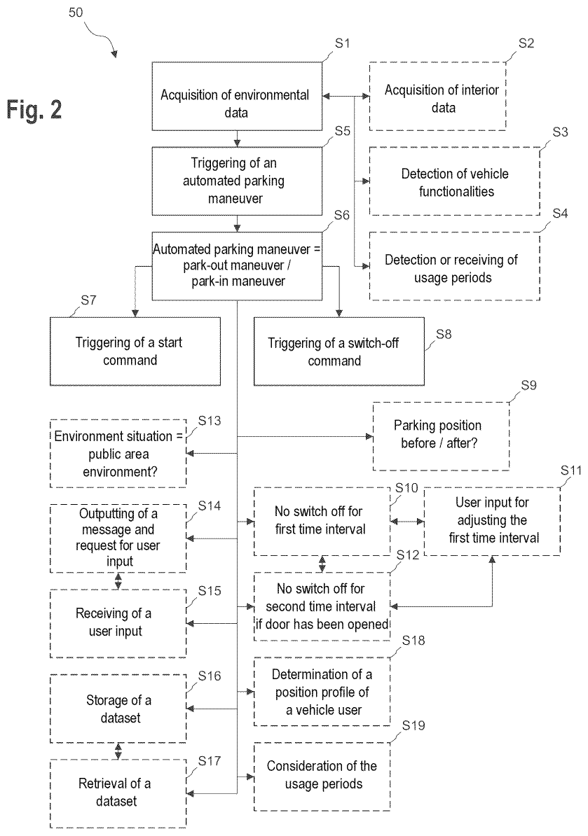

The vehicle 10 according to this embodiment additionally comprises a multimedia device 20, which is likewise coupled with the control device 12. By means of the multimedia device 20, a message can be outputted by the control device 12 to a vehicle user of the vehicle 10. In addition, a user input by the user of the vehicle 10 can be received by means of the multimedia device 20 and then transmitted to the control device 12. On the basis of the user input, changes can be made to the method presented in relation to FIG. 2.

The sensor device 18 is here adapted to acquire environmental data 24 in respect of an environment 22 of the vehicle 10. On the basis of the environmental data 24, objects, vehicles 10 and people in the environment 22 of the vehicle 10 can thus be recognized by the control device 12.

In addition, the sensor device 18 according to this embodiment is also adapted to acquire interior data 28 in respect of a vehicle interior 26 of the vehicle 10. On the basis of the interior data 28, the control device 12 can recognize, for example, whether a user of the vehicle 10 is in the vehicle interior 26.

Furthermore, the sensor device 18 according to this embodiment is also adapted to detect vehicle functionalities and to transmit corresponding measured values to the control device 12. For example, the sensor device 18 is here adapted to detect operations of opening a driver's door 30 of the vehicle 10.

Merely by way of example, the sensor device 18 according to this embodiment is additionally also adapted to detect people 32, for example in the region of a boot 34 of the vehicle 10, on the basis of the environmental data 24. Consequently, the control device 12 is able to recognize and track position profiles of people 32 in the environment 22 and in the vehicle interior 26 of the vehicle 10.

The control device 12 can also be coupled with a higher-level vehicle control device (not shown) of the vehicle 10, said vehicle control device detecting and controlling, for example, driving functions of the vehicle 10. Consequently, the higher-level vehicle control device can transmit to the control device 12 corresponding information which indicates whether the vehicle 10 is or is not used at a predefined time in respect of a driving function.

In an alternative, the control device 12 itself can be adapted to detect driving functions of the vehicle 10.

FIG. 2 shows a simplified schematic representation of a method 50 for operating a vehicle 10 according to one embodiment. Optional steps are shown by broken lines.

According to step S1, at least environmental data 24 of the vehicle 10 are acquired by the sensor device 18. This means that the environment 22 can be evaluated on the basis of the environmental data 24 in respect of objects, vehicles 10 and people 32 located in the environment.

Optionally, step S1 can also be enhanced by step S2, in which the sensor device 18 is also adapted to acquire interior data 28 in respect of a vehicle interior 26.

Alternatively or cumulatively, step S1 can also be enhanced by the optional step S3, in which the sensor device 18 is adapted to detect vehicle functionalities of the vehicle 10. By way of example, the sensor device 18 can be adapted to detect operations of opening a driver's door of the vehicle 10. The sensor device 18 can also be adapted to detect whether a door of the vehicle 10 is opened from the inside or from the outside. This makes it possible to conclude whether a user of the vehicle 10 leaves or enters the vehicle interior 26 at a specific time.

Furthermore, step S4 can be used, alternatively or cumulatively, to enhance step S1. Usage periods of the vehicle 10 are then likewise detected by the sensor device 18. For example, the sensor device 18 can detect whether the vehicle 10 is moving.

Alternatively, usage data about the usage periods can be received by the control device 12 from another device of the vehicle 10, for example from a higher-level vehicle control device. This allows conclusions to be drawn as to whether a vehicle 10 is being or has been used at a specific time.

In step S5 following step S1, an automated parking maneuver is triggered by a remote-control command of a user of the vehicle 10. To this end, the control device 12 can comprise or be coupled with a communication device, in particular a wireless communication device. The remote-control command can be triggerable, for example, by a smartphone, a tablet, an application (app) installed thereon or by a radio key fob.

There follows step S6, in which it is determined by the control device 12, at least on the basis of the acquired environmental data 24, whether the automated parking maneuver is a park-out maneuver or a park-in maneuver. To this end, the environmental data 24 can be evaluated, for example, by the control device 12 in respect of an environment 22 of the vehicle 10.

Consequently, a start command is triggered by the control device 12 in accordance with step S7 if the automated parking maneuver is a park-out maneuver determined by the control device 12. The vehicle 10 is not switched off in consequence of the start command. The user of the vehicle 10 is thus immediately able to use the vehicle further, for example in order to perform a driving function.

In an alternative, a switch-off command is triggered by the control device 12 in accordance with step S8 if the automated parking maneuver is a park-in maneuver determined by the control device 12. The vehicle 10 is switched off in consequence of the switch-off command. The fuel or energy expenditure of the vehicle 10 can thus be reduced.

The method 50 can then be enhanced by various optional steps, in particular in respect of the decision logic, which is provided in the control device 12 in order to determine whether the automated parking maneuver is a park-out maneuver or a park-in maneuver.

For example, the optional step S9 can be taken into account, in which the control device 12 determines whether the vehicle 10 is arranged in a (dedicated) parking position before the automated parking maneuver is performed or after the automated parking maneuver has been performed.

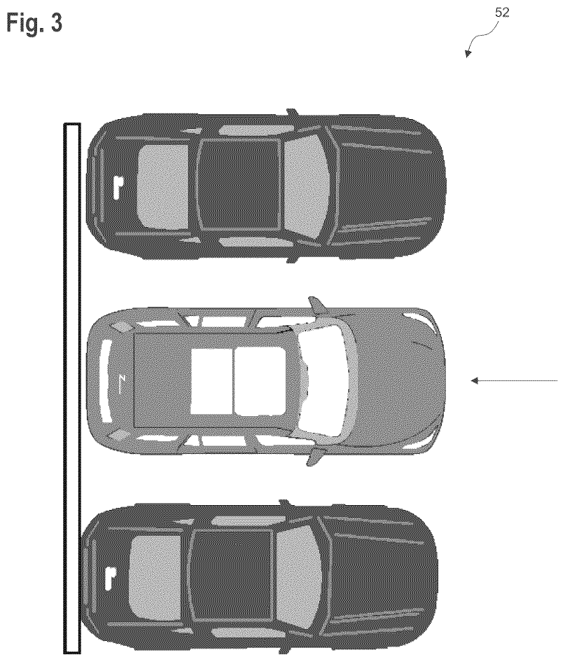

In this connection, FIGS. 3 to 5 show simplified schematic representations of examples of environment situations within the context of the method 50. FIG. 3 shows, for example, an environment situation 52 in which the vehicle 10 is brought into a dedicated parking position within the context of the automated parking maneuver (indicated by the arrow). This means that the vehicle 10 is not arranged in the parking position until after the automated parking maneuver has been performed. The parking position is here characterized in that the vehicle 10 is surrounded by adjacent vehicles 10 and an obstacle arranged behind the vehicle 10. Because the parking position has not been assumed until after the automated parking maneuver has been performed, the control device 12, on the basis of its decision logic, determines that the automated parking maneuver is a park-in maneuver. Consequently, the switch-off command is triggered by the control device 12.

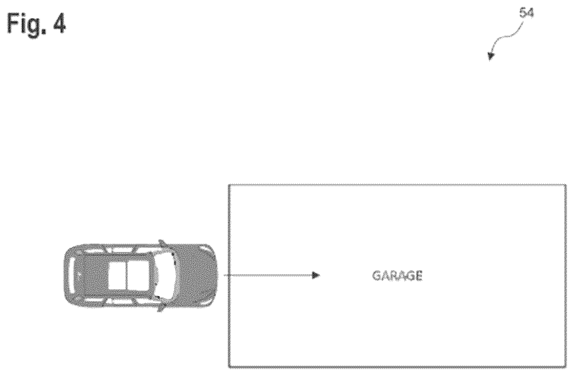

A further typical environment situation 54 is shown in FIG. 4. Here, the automated parking maneuver results in the vehicle 10 being moved into a garage (indicated by the arrow). This also characterizes a park-in maneuver and then results in a switch-off command being triggered by the control device 12.

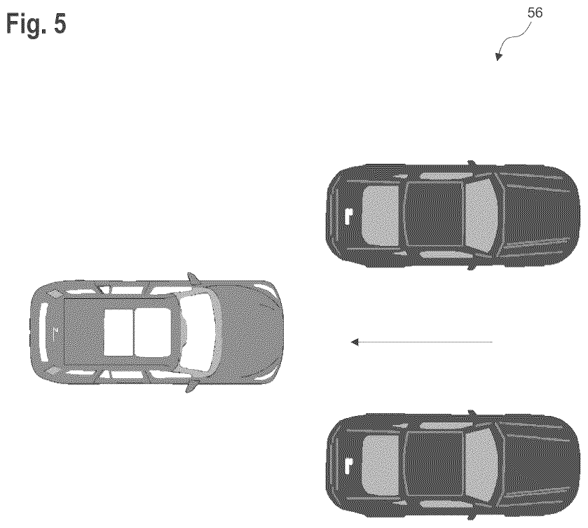

The environment situation 56 of FIG. 5, by contrast, shows that the vehicle 10, on the basis of the automated parking maneuver, has been removed from a parking position between vehicles 10 arranged adjacent thereto (indicated by the arrow), that is to say the vehicle 10 was arranged in the dedicated parking position before the automated parking maneuver. Consequently, the control device 12, in accordance with its decision logic, determines that the automated parking maneuver is a park-out maneuver and triggers the start command.

In accordance with the optional step S10, the vehicle 10 is not switched off in consequence of a start command at least for a first time interval. The user of the vehicle 10 is thus given time to carry out measures in preparation for a journey, for example to enter the vehicle 10.

Step S10 can be enhanced by the optional step S12. In accordance with the optional step S12, the vehicle 10 is not switched off in consequence of a start command at least for a second time interval if it is determined by the control device 12, on the basis of the vehicle functionalities detected by the sensor device 18, that a driver's door has been opened within the first time interval. The second time interval is longer than the first time interval. As already explained with reference to FIG. 1, the sensor device can also detect corresponding vehicle functionalities, for example the opening of the driver's door of the vehicle 10. On the basis thereof, the decision logic of the control device 12 can determine whether a driver enters the vehicle 10 after the automated parking maneuver has been performed. This indicates that the driver wishes to continue to use the vehicle 10.

The method 50 further provides the optional step S13, in which an environment situation of the vehicle 10 is determined by the control device 12. This is carried out on the basis of the environmental data 24 acquired by the sensor device 18. The control device 12 then determines that the automated parking maneuver is a park-out maneuver at least when the determined environment situation corresponds to a public area environment. This suggests that the user of the vehicle 10 wishes to continue to use the vehicle following the automated parking maneuver. Therefore, as a result of the determination that the parking maneuver is a park-out maneuver, the start command is triggered.

Optionally, the method 50 can also include step S14, in which a message to a vehicle user is triggered by the control device 12 via an output device of the vehicle 10. The multimedia device 20 (multifunctional device) of the vehicle 10 can in particular be used for this purpose. The message includes information about the triggered start command or switch-off command. In addition, the message includes a request for a user input, by means of which the triggered start command or switch-off command can be overridden. If a user input is not made in response to the request, the triggered start command or switch-off command is not overridden. The user of the vehicle 10 is thus informed of the command that has been triggered and is given the opportunity to correct it.

In accordance with the optional step S15, a user input is received on the basis of an input device of the vehicle 10 and is transmitted to the control device 12. The multifunctional device 20 can likewise be used for this purpose. In consequence of the user input, the command triggered by the control device 12 is optionally corrected (overridden), at least where this is indicated by the user input.

The method 50 can also be enhanced by the optional step S16, in which the control device 12 stores a dataset in the memory device 16 in consequence of a triggered automated parking maneuver. The dataset comprises at least activity information, a time value and/or a location value. The activity information indicates whether a start command or a switch-off command has been triggered in consequence of the automated parking maneuver that was triggered and/or whether a respective start command or a switch-off command has been corrected by a user input. The time value indicates a time of day at which the automated parking maneuver was triggered. The location value indicates a position at which the automated parking maneuver was triggered. A database can thus be built in respect of the automated parking maneuvers that have been triggered in the past. Consequently, a repeated user behavior can be tracked and it can be assessed whether the switch-off commands or start commands triggered by the control device 12 were appropriate. This helps to increase the accuracy of the decision logic of the control device 12, in order to make decisions in accordance with a user's wishes.

The position information for the location value can be determinable, for example, on the basis of a navigation signal receiver of the vehicle 10.

The time information for the time value is determined on the basis of a system clock of the vehicle 10.

The database so built within the memory device 16 can be used in accordance with the optional step S17 to retrieve a dataset from the memory device 16 by the control device 12 in consequence of a triggered automated parking maneuver. The dataset that best corresponds in terms of its time value and/or location value to the time value and/or location value of the automated parking maneuver in question is chosen. However, it is assumed that the user behavior exhibits repetitions in respect of the automated parking maneuver. On the basis of the retrieved dataset, it is possible to track, by means of the activity information of the dataset, whether a park-in maneuver or a park-out maneuver is to be assumed in respect of the automated parking maneuver in question. Consequently, the control device 12 triggers a start command or a switch-off command in dependence on the activity information of the retrieved dataset.

On the basis of the optional step S18, a position profile of a vehicle user of the vehicle 10 can be determined by the control device 12. To this end, the control device 12 can use environmental data 24 and/or interior data 28 which have been acquired by the sensor device 18. The position profile of the vehicle user of the vehicle 10 makes it possible to conclude whether the automated parking maneuver is a park-in maneuver or a park-out maneuver. This can be correspondingly taken into account by the control device 12 in its decision logic.

The method 50 can further be enhanced on the basis of the optional step S19, in which the control device 12 considers usage periods of the vehicle 10 which have been detected by the sensor device 18 and/or considers usage data which the control device 12 has received by other means, for example from a higher-level vehicle control device. The usage data likewise indicate the periods in which the vehicle 10 has been used. By means of the time information, the control device 12 can then determine whether the vehicle 10 has been used in advance of the automated parking maneuver. If that is the case, it can be assumed that the automated parking maneuver is a park-in maneuver. Otherwise, the control device 12 assumes that the automated parking maneuver is a park-out maneuver.

The control device 12 can thus use different information to determine the nature of the automated parking maneuver. In particular, the control device 12 can use stored empirical values from past decision processes in order to make a decision. A comprehensive decision logic of the control device 12 is thus provided, on the basis of which it is possible to estimate in the best possible way whether the user intends to continue to use the vehicle 10 following the automated parking maneuver or whether the vehicle 10 has been parked in an at least temporary parking position by the automated parking maneuver. Since the commands triggered by the control device 12 can be corrected by means of user inputs, the variability of the method 50 is high. In addition, the method 50 ensures increased user comfort and a reduced fuel or energy expenditure of the vehicle 10.

Specific embodiments disclosed herein use circuits (e.g. one or more circuits) to implement standards, protocols, methods or technologies disclosed herein, to functionally couple two or more components, to generate information, to process information, to analyze information, to generate signals, to encode/decode signals, to convert signals, to transmit and/or to receive signals, to control other devices, etc. Circuits of any kind can be used.

In one embodiment, a circuit such as the control device comprises, inter alia, one or more data processing devices such as a processor (e.g. a microprocessor), a central processing unit (CPU), a digital signal processor (DSP), an application-specific integrated circuit (ASIC), a field-programmable gate array (FPGA), a system on a chip (SoC) or the like or any desired combinations thereof and can comprise discrete digital or analog circuit elements or electronics or combinations thereof. In one embodiment, the circuit comprises hardware circuit implementations (e.g. implementations in analog circuits, implementations in digital circuits and the like as well as combinations thereof).

In one embodiment, circuits comprise combinations of circuits and computer program products with software or firmware commands, which are stored on one or more computer-readable memories and cooperate in order to cause a device to execute one or more of the protocols, methods or technologies described herein. In one embodiment, the circuit technology comprises circuits, such as, for example, microprocessors or parts of microprocessors, which require software, firmware and the like for operation. In one embodiment, the circuits comprise one or more processors or parts thereof and the associated software, firmware, hardware and the like.

Reference may be made in this disclosure to quantities and numbers. Unless explicitly stated, such quantities and numbers are not to be considered to be limiting but rather as examples of the quantities or numbers that are possible in connection with the disclosure. In this connection, the term “plurality” may also be used in the disclosure to refer to a quantity or number. In this connection, the term “plurality” means any number greater than one, for example two, three, four, five, etc. The terms “about”, “approximately”, “close to” etc. mean plus or minus 5% of the stated value.

Although the disclosure has been represented and described in relation to one or more embodiments, a person skilled in the art, after reading and understanding this description and the accompanying drawings, will be able to make equivalent changes and modifications.

That which is claimed is:

1. A method for operating a vehicle having at least one sensor device and a control device coupled with the sensor device, wherein the method comprises:
acquiring at least environmental data of the vehicle by the sensor device,
triggering an automated parking maneuver by a remote-control command of a user of the vehicle,
determining by the control device, at least on the basis of the acquired environmental data, whether the automated parking maneuver is a park-out maneuver or a park-in maneuver, and
triggering a start command by the control device if the automated parking maneuver is a park-out maneuver determined by the control device, wherein the vehicle is not switched off in consequence of the start command, or
triggering a switch-off command by the control device if the automated parking maneuver is a park-in maneuver determined by the control device, wherein the vehicle is switched off in consequence of the switch-off command.

2. The method according to claim 1, wherein the automated parking maneuver is determined by the control device as being a park-out maneuver at least when the control device determines, on the basis of the acquired environmental data, that the vehicle was arranged in a dedicated parking position before the automated parking maneuver.

3. The method according to claim 1, wherein the automated parking maneuver is determined by the control device as being a park-in maneuver at least when the control device determines, on the basis of the acquired environmental data, that the vehicle is arranged in a dedicated parking position after the automated parking maneuver.

4. The method according to claim 1, wherein the vehicle is not switched off in consequence of a start command at least for a first time interval.

5. The method according to claim 4, wherein vehicle functionalities are also detected by the at least one sensor device, and in that the vehicle is not switched off in consequence of a start command at least for a second time interval if, on the basis of the detected vehicle functionalities, it is determined by the control device that a driver's door has been opened within the first time interval, wherein the second time interval is longer than the first time interval.

6. The method according to claim 4, wherein at least the first time interval is adjustable within a predefined time interval by a user input.

7. The method according to claim 1, wherein the method further comprises:
determining by the control device an environment situation in which the vehicle is arranged, at least on the basis of the acquired environmental data, wherein the control device determines that the automated parking maneuver is a park-out maneuver at least when the determined environment situation corresponds to a public area environment.

8. The method according to claim 1, wherein the method further comprises:
outputting a message to a vehicle user by the control device via an output device of the vehicle, wherein the message includes information about the triggered start command or switch-off command, wherein the message includes a request for a user input, by means of which the triggered start command or switch-off command can be overridden, and wherein, if a user input is not made in response to the request, the triggered start command or switch-off command is not overridden.

9. The method according to claim 8, wherein the method further comprises:
receiving a user input via an input device of the vehicle, wherein the triggered start command or switch-off command is overridden by the user input.

10. The method according to claim 1, wherein the vehicle comprises a memory device coupled with the control device, and in that the method further comprises:
storing a dataset in the memory device by the control device in consequence of a triggered automated parking maneuver, wherein the dataset comprises at least activity information, a time value and/or a location value, wherein the activity information indicates whether a start command or a switch-off command has been triggered in consequence of the triggered automated parking maneuver and/or whether a respective start command or a switch-off command has been corrected by a user input, wherein the time value indicates a time of day at which the automated parking maneuver was triggered, and wherein the location value indicates a position at which the automated parking maneuver was triggered.

11. The method according to claim 10, wherein the method further comprises:
retrieving a dataset from the memory device by the control device, in consequence of a triggered parking maneuver, on the basis of the time value and/or the location value for the triggered parking maneuver, and
triggering a start command or a switch-off command in dependence on the activity information of the retrieved dataset.

12. The method according to claim 1, wherein at least interior data of a vehicle interior of the vehicle are also acquired by the sensor device, and in that the method further comprises:
determining a position profile of a vehicle user by the control device on the basis of the acquired environmental data and/or interior data, and
determining by the control device, at least on the basis of the determined position profile of the vehicle user, whether the automated parking maneuver is a park-out maneuver or a park-in maneuver.

13. The method according to claim 1, wherein the method further comprises:
acquiring at least also usage periods of the vehicle by the sensor device, and/or
receiving usage data of the vehicle by the control device, wherein the usage periods of the vehicle are established by the usage data, and
determining by the control device, at least on the basis of the usage periods of the vehicle, whether the automated parking maneuver is a park-out maneuver or a park-in maneuver.

14. A vehicle, comprising:
at least one sensor device; and
a control device coupled with the sensor device, wherein the sensor device is at least adapted to acquire at least environmental data of the vehicle, and wherein the control device is at least adapted to:
trigger an automated parking maneuver of the vehicle in consequence of a remote-control command received from a user,
determine, at least on the basis of the acquired environmental data, whether the automated parking maneuver is a park-out maneuver or a park-in maneuver, and
trigger a start command if the automated parking maneuver is a park-out maneuver determined by the control device, wherein the vehicle is not switched off in consequence of the start command, and
trigger a switch-off command if the automated parking maneuver is a park-in maneuver determined by the control device, wherein the vehicle (10) is switched off in consequence of the switch-off command.
